(19) United States
(12) Patent Application Publication
(10) Pub. No.: US 2017/0228600 A1
(43) Pub. Date: Aug. 10, 2017

(54) ANALYSIS OF VIDEO GAME VIDEOS FOR INFORMATION EXTRACTION, CONTENT LABELING, SMART VIDEO EDITING/CREATION AND HIGHLIGHTS GENERATION

(71) Applicant: ClipMine, Inc., Mountain View, CA (US)

(72) Inventors: Zia Syed, Sunnyvale, CA (US); Farhan Zaidi, Sunnyvale, CA (US); Ivana Savic, San Lorenzo, CA (US); Saad Ali, San Jose (US); Omar Javed, Mountain View, CA (US); Jiangbo Yuan, San Jose, CA (US); Manas Paldhe, Sunnyvale, CA (US)

(73) Assignee: ClipMine, Inc., Mountain View, CA (US)

(21) Appl. No.: 15/019,766

(22) Filed: Feb. 9, 2016

(51) Int. Cl. G06K 9/00; A63F 13/537; G11B 27/22; A63F 13/63; G06K 9/18; G11B 27/036

(52) U.S. Cl. CPC G06K 9/00751; G06K 9/18; G11B 27/036; G11B 27/22; A63F 13/63; A63F 13/537

(57) ABSTRACT

Methods and systems for analyzing video-game videos in connection with facilitating video editing and creation and performing automated extraction of information of interest to facilitate labeling of and/or highlight generation for such videos is provided. According to one embodiment, a video, containing content pertaining to a video game, is received by a video-game video analysis system. Information regarding the status of the video game over time is received by retrieving game metadata through an API of the video game or by analyzing audio or visual features within the content. Multiple clips are automatically identified within the video for proposed inclusion within an edited version of the video based on the status of the video game over time. The edited version of the video is then generated by (i) joining the automatically identified clips or (ii) joining multiple user-selected clips, including at least one clip selected from the automatically identified clips.

### CROSS-REFERENCE TO RELATED APPLICATIONS

This application claims the benefit of priority to U.S. Provisional Application No. 61/115,072, filed on Feb. 11, 2015, which is hereby incorporated by reference in its entirety for all purposes.

Embodiments of the present invention described in this application may also relate to subject matter contained in and/or be used in conjunction with the network-based video discovery and consumption service described in copending and commonly-owned U.S. patent application Ser. No. 14/542,071, filed on Nov. 14, 2014, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2015-2016, ClipMine, Inc.

### BACKGROUND

Field

Embodiments of the present invention generally relate to image processing and processing video content to facilitate video editing/creation and efficient consumption. In particular, embodiments of the present invention relate to information extraction from, and labeling of, video game videos and streams and automated methods for image and video processing to facilitate content labeling, video editing/creation and highlights generation from such videos and streams.

Description of the Related Art

In recent years, digital distribution of videos and viewing of videos on devices connected to a network has become common. These videos may contain a variety of content that may be for entertainment, informational or educational purposes. One category of video content that has become increasingly popular recently, is video game videos. The videos in this category focus on video gaming, including playthroughs of video games by users, broadcasts of video game competitions and other gaming-related events. Websites like Twitch.tv, gameing.youtube.com or Hitbox.tv have become popular by streaming videos of live video gaming sessions and also distributing recordings of past video game sessions. Users interested in watching video gaming content can go to these websites, select a game and watch people playing that video game.

Traditionally, these game videos are created, edited and labeled manually by uses reviewing raw captured video, selecting one or more portions to be included within a video to be shared and then labeling the content of the video (e.g., what game is being played, the genre of the video game, who is playing the game, how well the game is being played, etc.). Users are then able to review such manually generated labels to decide which video to watch.

The number of live and recorded video game videos available for viewing is growing rapidly. This makes it cost and time prohibitive to manually provide detailed labels and descriptions of the video game content. Moreover, in the context of live streams, the video game might become more (or less) interesting as the game progresses depending on how well the player is playing or how well a competitive match between multiple players is progressing. It would be desirable to facilitate selection and consumption of video-game videos by automatically integrating labels with such content to create a table of contents (ToC) for such videos, thereby allowing viewers to easily identify and jump to segments of interest within videos or watch only those portions of the videos of importance.

There are millions of gamers broadcasting their gameplay. Once they are done streaming, gamers spend significant amount of time and effort editing hours of recorded gameplay in order to create more meaningful, shorter video content and highlights for their fans. The editing process includes manually locating and removing ‘dead-air’ (parts with little or no action) in videos, locating interesting clips, joining separate clips via transitions, adding music, and adding text headings, among other things. It would be desirable to have a system automatically perform some or all of these tasks so as to significantly reduce the time and effort of the gamers in creating more interesting game videos.

### SUMMARY

Methods and systems are described for analyzing video-game videos in connection with facilitating video editing and creation and performing automated extraction of information of interest to facilitate labeling of and/or highlight generation for such videos. According to one embodiment, a video, containing content pertaining to a video game, is received by a video-game video labeling, information extraction, smart editing and highlight generation system. Information relating to a status of the video game over time is received by retrieving game metadata through an Application Programming Interface (API) of the video game or by analyzing audio or visual features within the content. Multiple clips are automatically identified within the video for proposed inclusion within an edited version of the video based on the status of the video game over time. The edited version of the video is then generated by (i) joining all of the automatically identified clips or (ii) joining multiple user-selected clips, including at least one clip selected from the automatically identified clips.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 shows an example of a game screen containing multiple HUDs.

FIG. 2 is a generalized block diagram illustrating various functional modules of a video-game video labeling, information extraction, smart editing and highlight generation system in accordance with an embodiment of the present invention.

FIG. 3 illustrates processing performed by an exemplary game video feature extraction module in accordance with an embodiment of the present invention.

FIG. 4 illustrates processing performed by an exemplary game video labeling and information extraction module in accordance with an embodiment of the present invention.

FIG. 5 illustrates processing performed by an exemplary watchability scoring and highlight generation module in accordance with an embodiment of the present invention.

FIG. 6 illustrates a simplified database schema for an exemplary video game database in accordance with an embodiment of the present invention.

FIG. 7 illustrates a simplified database schema for a game video information database in accordance with an embodiment of the present invention.

FIG. 8 illustrates an exemplary graphical interface incorporating information extracted and/or generated by a video-game video labeling, information extraction and highlight generation system in accordance with an embodiment of the present invention.

FIG. 9 is an exemplary computer system in which or with which embodiments of the present invention may be utilized.

### DETAILED DESCRIPTION

Methods and systems are described for analyzing video-game videos in connection with facilitating video editing and creation and performing automated extraction of information of interest to facilitate labeling of and/or highlight generation for such videos. Almost all video games have a certain structure to their content. For example, the video games need to provide information to the video game player about his/her status in the game. This is usually done with one or more Head Up Displays (HUDs). Moreover, the progress of the player(s) with respect to the objective of the game is typically also displayed in the HUD. An achievement, within a video game, also sometimes known as a trophy, badge, award, stamp, medal or challenge, is a meta-goal defined outside of the video game's parameters. These achievements are usually indicated by specific graphical elements and/or sounds in the video game. Based on the type of video game, a map may be also be displayed within the HUD, indicating, among other things, the location of the player in the game world. All of these elements provide rich information about the game type, player status, the player's progress, the player's likelihood of success and the likelihood of the game being riveting for the viewers. Embodiments of the present invention provide content-specific video analysis within video indexing and editing tools that facilitate video editing, creation and/or sharing.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While in various embodiments of the present invention are described in the context of desktop computer systems, laptop computers, tablet computers, smartphones and their associated web browsers and video players presented therein, the methodologies described herein are equally applicable to plug-ins or extensions to web browsers, web applications, mobile applications and tablet applications. Furthermore, the end user devices may include television (TV) sets. As such, those skilled in the art will appreciate the video processing (e.g., editing, creation, stitching and labeling) functionality described herein may be integrated within a TV app or a media player provided by video streaming services (e.g., Netflix or Hulu).

Brief definitions of terms used throughout this application are given below.

The term “annotation” broadly refers to user-supplied or automatically generated content that is associated with a portion of video content or a video “clip” (e.g., one or more frames of video content corresponding to a particular time or period of time within a video). Depending upon the particular implementation, annotations may include, but are not limited to, one or more of labels, tags, comments and additional content. As discussed further below, labels may be text-based and may include one to a few words or may be longer to be more descriptive of a particular moment or moments in a video. In some embodiments, a tag or a label may be in the form of a hash tag that is similar to hash tags on Twitter. Labels or tags may also have a description. Labels and tags may include facts that are descriptive of the content associated with a portion of video content or within a clip and/or emotional tags representative of a user's emotional reaction to the portion of video content or about something that happened within the portion of video content. An example of an emotional tag is “I love this!”. An emotional tag can also be in the form of an icon (e.g., an emoticon). Emotions may be associated with an annotation and may be a stored/noted property. In addition, users may be able to attach emotions/reactions (e.g., funny, outrageous, crazy, like, dislike) to existing annotations or other parts of videos. Facts may represent stored/noted properties of an annotation and may be limited to describe the annotation using terminology used in the video and/or external repositories (e.g., Wikipedia). Comments may include text and may be questions or opinions provided by a user. The context of a comment can be emotional and users may also be provided with various sets of emoticons from which they may select. Users may also be provided with the ability to associate various types of content and data with an annotation, including, but not limited to, hyperlinks, images and files. In some embodiments, annotations may also be linked to other annotations from the same or different videos. This linking may be manually defined by users and/or automatically determined based on user provided data.

The terms “connected” or “coupled” and related terms are used in an operational sense and are not necessarily limited to a direct connection or coupling.

The term “client” generally refers to an application, program, process or device in a client/server relationship that requests information or services from another program, process or device (a server) on a network. Importantly, the terms “client” and “server” are relative since an application may be a client to one application but a server to another.

The term “clip” generally refers to a continuous portion or segment of a video having a start time and an end time. A clip may have one or more annotations associated therewith. In some embodiments, users may modify the start and/or end time of the clip. In one embodiment, clips may be shared with other users and a clip can be part of a highlight video.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The term “label” generally refers to a type of an annotation comprising a set of one or more of text-based characters (e.g., American Standard Code for Information Interchange (ASCII) characters, alphanumeric characters, non-alphanumeric characters and characters representing the alphabet of various languages in various fonts and/or sizes), text symbols (e.g., [symbol] , [symbol] , ⋆, [symbol] , [symbol] , [symbol] , [symbol] , [symbol] , [symbol] , [symbol] , [symbol] , [symbol] , etc.), emoji, ideograms, smileys, icons or other visually perceptible information that is associated with a portion of video content (e.g., one or more frames of video content corresponding to a particular time or period of time within a video) or a clip. Depending upon the particular implementation, the label may include one or more words and/or be in the form of one or more hash tags (e.g., hash tags similar to those used in the context of Twitter). A label or proposed/suggested label may be user-generated or automatically generated based upon contextual analysis, for example, of the portion of video content at issue. Labels may represent content or descriptive information about the particular portion of video content and/or may include emotional tags, for example, representing a user's emotion or reaction to or about something within the particular portion of video content.

If the specification states a component or feature “may”, “can”, “could”, or “might” be included or have a characteristic, that particular component or feature is not required to be included or have the characteristic.

The term “responsive” includes completely or partially responsive.

The term “server” generally refers to an application, program, process or device in a client/server relationship that responds to requests for information or services by another program, process or device on a network. The term “server” also encompasses software that makes the act of serving information or providing services possible.

The term “site,” “website,” “third-party website” and the like generally refer to an online-accessible application that allows users to view videos containing video game content, including playthroughs of video games by users, broadcasts of video game competitions and/or other gaming-related events. Non-limiting examples of sites include YouTube, GameSpot, Destructoid, Twitch and Hitbox. Sites may stream live and/or recorded single-player or multiplayer video gaming sessions, large-scale gaming competitions and/or video game industry events.

The term “user,” when used in the context of the system, generally refers to an individual having access to any part of the system. In one embodiment, users can sign up for an account with the system and become a member or subscriber by using a third-party social media account (e.g., a Facebook, Twitter or Google plus account). In some embodiments of the present invention, users may provide content (e.g., proposed labels, annotations, likes/dislikes) that are saved by the system by using an annotation tool and/or a management platform. There may be various types and/or groups of users (e.g., viewers, players, administrators, moderators of content, basic members and users with privileged status, such as editors or super-users). Users may also interact with the system in multiple roles at different times (e.g., When a user is creating video content, he/she may be referred to as a “creator.” Alternatively, when a user is simply viewing a highlight video, he/she may be referred to as a “viewer,” whereas at other times, when the user is participating as a player in a video game, he/she may be referred to as a “player”). As such, those skilled in the art will appreciate such labels are not mutually exclusive.

The term “video” generally refers to a visual multimedia source (e.g., a file or stream) that contains a sequence of images, audio and/or other data, which when played are perceived by the human eye as a moving picture. Videos include recordings, reproduction or broadcasting of moving visual images that may contain sound and/or music. A video may represent media streamed from prerecorded files or may be distributed as part of a live broadcast feed. In embodiments of the present invention, video game videos typically contain digital content related to playthroughs of video games by game players, multiple players competing or cooperatively playing with each other in a video game and/or other gaming-related events. Video streams or streaming video is content typically sent in compressed form over a network (e.g., the Internet) and displayed to the viewer in real time. With streaming video, a networked user does not have to wait to download a file to play it. Instead, the media is sent in a continuous stream of data and is played as it arrives. As used herein, the term “video” is intended to encompass video content (typically also including audio content and other data) regardless of whether it is compressed or uncompressed and regardless of whether it is streamed or downloaded completely before playback can be performed.

The term “video editing” generally refers to the process of modification of a video. An example of modification is cutting out or extracting a clip (or clips) from a video, and/or joining multiple clips together to create a new video. The term “video transition” is a way in which two video clips may be joined together, for example, if one clip changes instantly to the next then the transition is referred to as a “cut transition.” If a clip is progressively replaced by another clip then the transition is referred to a “wipe transition.” Additional forms of video modification include changes to audio/visual properties of a video, for example, changing the brightness of the video, adding images to the video, overlaying text on video, mixing audio, or replacing the audio of a video with another audio track not originally associated with the video.

The terms “video highlights,” “highlights,” or “highlight video” generally refers to a set of associated clips from a video or across multiple videos that are intended to represent a summarization of the video(s), portions of the video(s) deemed to be important, conspicuous, memorable or of particular interest to viewers in general or the system user. In embodiments of the present invention, highlight videos can be automatically generated by a watchability scoring and highlight generation module that differentiates between ‘interesting’ games or portions thereof and ‘boring’ ones or portions thereof through generation of watchability scores. For example, as described in further detail below, one or more significant portions of the video(s) containing game activity deemed to be of importance and one or more less significant portions of the video(s) deemed to be relatively less important may be identified based on various factors including, but not limited to, input received from the user and changes in game status and/or game activity. Such highlight videos can be shared with other users (e.g., members or subscribers) of a cloud-based video game video labeling, information extraction, smart editing and highlight generation system (which may be referred to herein simply as the “system”) and/or users outside of the system (e.g., third-party video sharing systems including, but not limited to, youtube.com and vimeo.com). In embodiments of the present invention, highlight videos may be presented to users within a graphical user interface of a proprietary video player along with a list of hyperlinks and/or ToC objects. For example, the system may present the user with a hyperlink for each clip in a highlight video that allows the user to skip to the particular highlights they wish to view by selecting the corresponding hyperlinks. Alternatively, the user may view the highlight video from beginning to end.

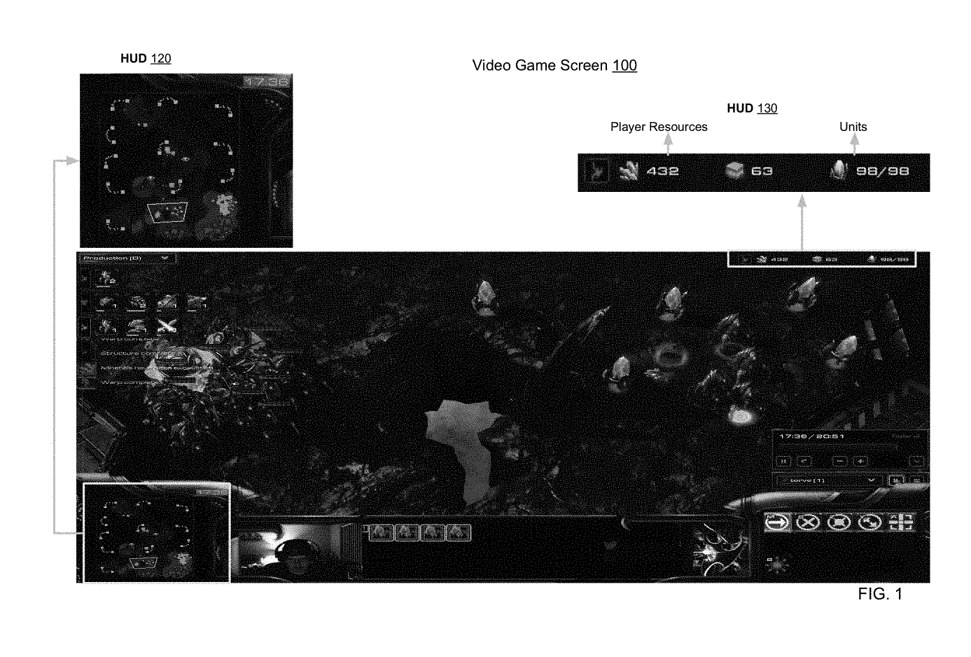

FIG. 1 shows an example of a game screen 100 containing multiple HUDs 120 and 130. In the context of the present example, game screen 100 is one displayed to players of the video game StarCraft II™. Game screen 100 includes two HUDs 120 and 130, which have been blown up to facilitate readability. HUD 120 provides a map illustrating player unit locations within the virtual game world. Such an HUD may also provide, among other things, information regarding an amount of time that has elapsed during game play, a current time and enemy unit locations. HUD 130 is a player resource indicator that provides information regarding types and amounts of resources and units available and/or deployed. Those skilled in the art will appreciate game screen 100 is merely used as an example and that other game screens may include more or fewer HUDs and use different structural graphical user interface (GUI) elements.

In embodiments of the present invention, HUDs (e.g., HUDs 120 and 130) and other structural graphical user interface (GUI) elements of video games are exploited by a content-specific video editor that understands the content at issue by performing image analysis, audio analysis and/or Optical Character Recognition (OCR) on video content pertaining to a video game to obtain information relating to a status of the video game at a particular time and/or over time and to facilitate generic and/or customized highlight generation. As described in further detail below, the systems and methods described herein facilitate video creation and editing and provide an approach for labeling videos containing video gaming content, including but not limited to extraction of information regarding the name of the video game at issue, names, health, levels and/or scores of players involved in the video game, the genre of the video game, a particular level within the video game, player achievements within the video game, a measure of the excitement level of the video game, viewer interest potential of one or more portions of the video (e.g., by identifying significant portions of the video containing game activity deemed to be of importance). The systems and methods described herein also facilitate annotating, organizing and sharing such information about the video game content.

The extraction and use of this data is thought to result in, among other benefits, one or more of the following: (i) improved search and retrieval of video game videos; (ii) better categorization and labeling of live and recorded video games; (iii) automatic differentiation between ‘interesting’ games from ‘boring’ ones through generation of watchability scores; (iv) better in-video navigation and highlighting of regions of interest within the video game and game activity heat maps for viewers; (v) assistance to users in connection with editing videos by automatically removing or identifying dead content, labeling game sessions and highlighting game achievements; and (vi) the ability to automatically generate personalized video game highlights and walkthroughs.

In some embodiments, systems and methods are provided for highlight generation (also referred to as “summarization) from videos of video game play. Automatic highlight generation may take into account available game information (i.e., information regarding user score, on screen activity, achievements, and nearness to game objectives) to select the most significant and/or interesting clips of the video as highlights. The game information can come from auto-processing (e.g., feature extraction from the video) or from game metadata obtained via an Application Programming Interface (API) of a video game. Moreover, depending upon the particular implementation, highlights may be generated completely automatically (generic highlight generation) or the system may received information from the user regarding the duration of the highlights, desired game activity and/or selection of video clips for inclusion in the highlights (to produce a customized highlights video for the user).

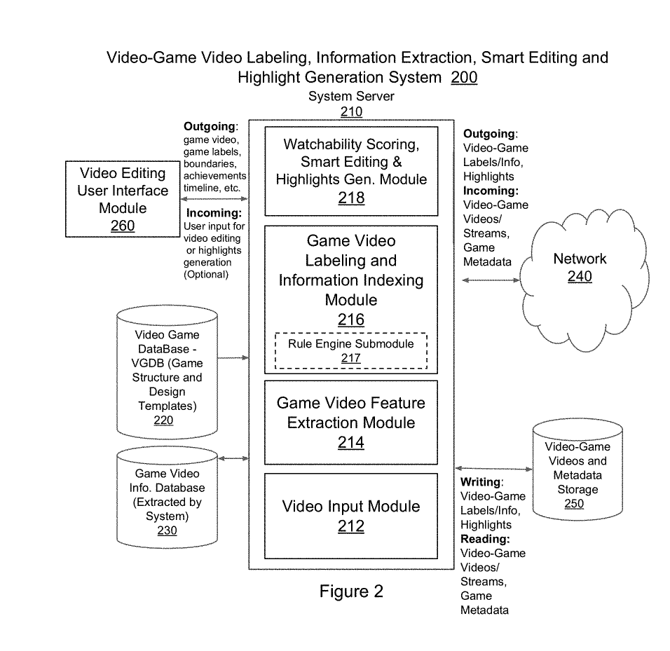

FIG. 2 is a generalized block diagram illustrating various functional modules of a video-game video labeling, information extraction, smart editing and highlight generation system 200 in accordance with an embodiment of the present invention. In the context of the present example, system 200 is presented in the form of a cloud-based system server 210 that has access to game videos and game metadata (optional). The videos and/or metadata may be read from a video-game video storage 250 or another form of computer-readable medium (e.g., a hard drive, optical disk or other digital media) and/or the videos may be received from a remote source via a network 240 (e.g., the Internet).

In one embodiment, system server 210 supports processing of multiple videos in parallel and includes a video input module 212, a game video feature extraction module 214, a game video labeling and information indexing module 216 and a watchability scoring and highlight generation module 218. The user can optionally provide inputs for video editing and/or highlights generation via the user input module 260.

Video input module 212 receives game data (in the form of game video and optionally game metadata) for a particular game video and routes appropriate portions to other functional modules for processing. For example, if game metadata associated with the particular game video is available, the game metadata may be sent directly to watchability scoring and highlight generation module 218. Meanwhile, video imagery and audio of the video at issue may be sent to game video feature extraction module 214.

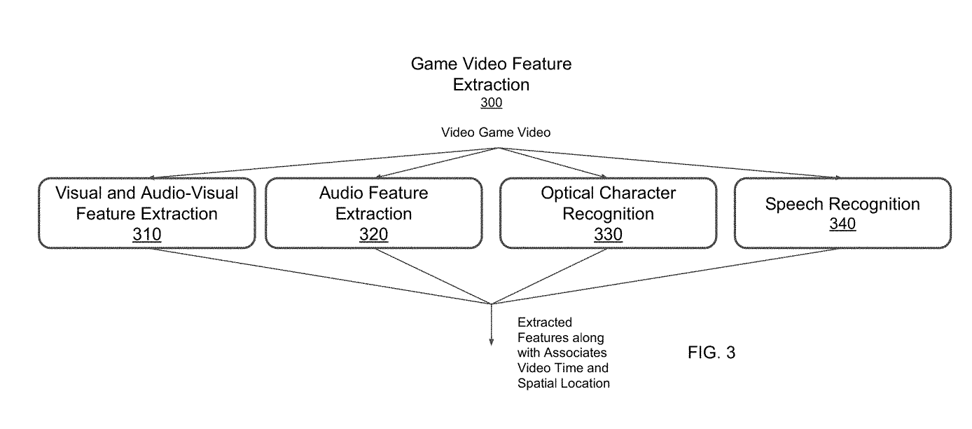

Game video feature extraction module 214 extracts various features from the video imagery and audio content of the video. According to one embodiment, game video feature extraction module 214 extracts several automatic video indexing features from the video imagery using one or more local invariant feature detectors as described in, for example, Tinne Tuytelaars and Krystian Mikolajczyk. “Local invariant feature detectors: a survey,” Found. Trends. Comput. Graph. Vis. vol. 3, no. 3 (July 2008), which is hereby incorporated by reference in its entirety for all purposes. The extracted features are sent to game video labeling and information indexing module 216. Non-limiting examples of various processing that may be performed by game video feature extraction module 214 are described in further detail below with reference to FIG. 3.

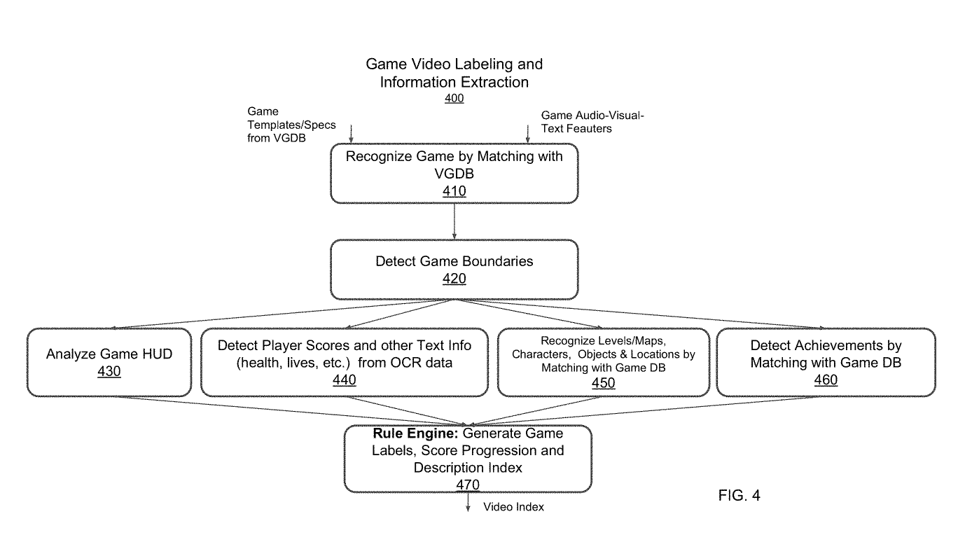

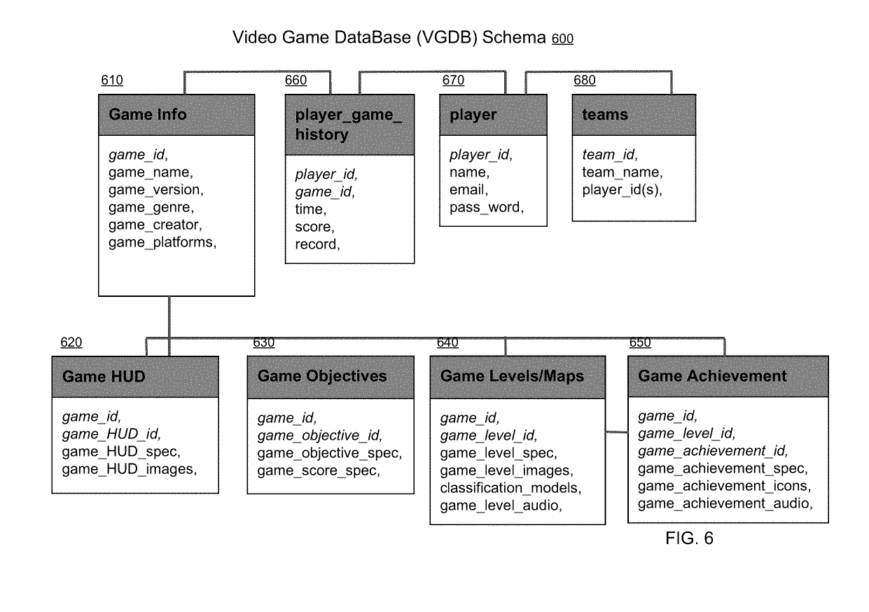

Game video labeling and information indexing module 216 is configured to identify the video game represented within the video data and extract various information relating to the status of the video game over time. According to one embodiment, game video labeling and information indexing module 216 module uses game design templates stored within a video game database (VGDB) 220 to recognize the video game being shown in the video data. An exemplary process of game video labeling and information indexing is described in further detail below with reference to FIG. 4. A non-limiting example of a simplified database schema for VGDB 220 is described in further detail below with reference to FIG. 6.

Game video labeling and information indexing module 216 may also extract information relating to the status of the video game and/or game activity over time, including scores, player health information, a game map, a game level. Game video labeling and information indexing module 216 may additionally detect any achievements or medals that have been received by players. In one embodiment, game video labeling and information indexing module 216 contains a rule engine submodule 217 that implements the game logic and is separate from lower level classifiers and detectors. Rule engine submodule 217 uses the game knowledge stored in VGDB 220 and the information received from game feature extraction module 214 to generate game labels and descriptions. The separation of rule engine submodule 217 from VGDB 220 makes it easy to deal with new video games, as only VGDB 220 needs to be updated with the video game knowledge, and rule engine submodule 217 can use this to generate labels for any video showing that game. Non-limiting examples of various processing that may be performed by game video labeling and information extraction module 216 are described in further detail below with reference to FIG. 4.

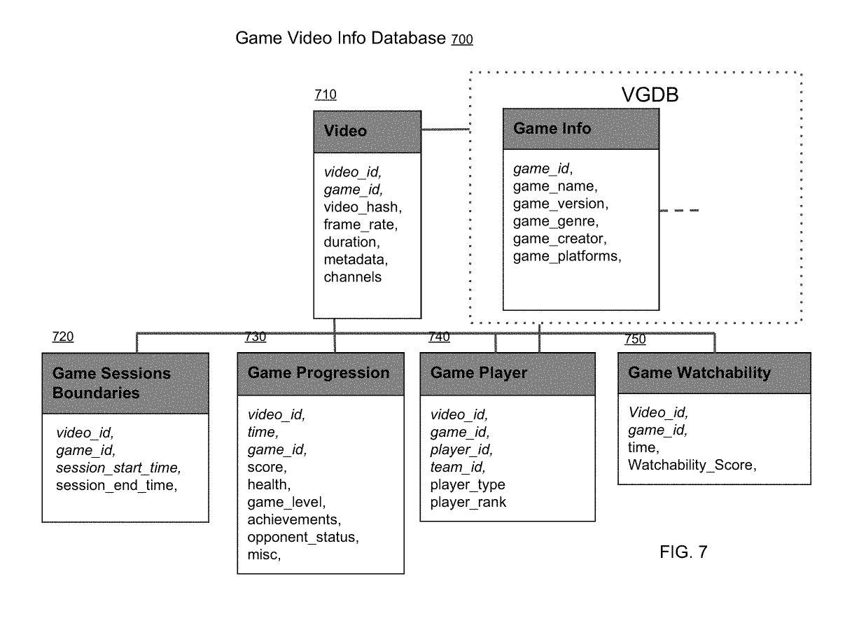

After extracting the status of the video game and/or game activity, game video labeling and information indexing module 216 indexes the extracted information and stores it within a game video information database 230. A non-limiting example of a simplified database schema for game video information database 230 is described in further detail below with reference to FIG. 7. The extracted information may also be sent to watchability scoring and highlight generation module 218.

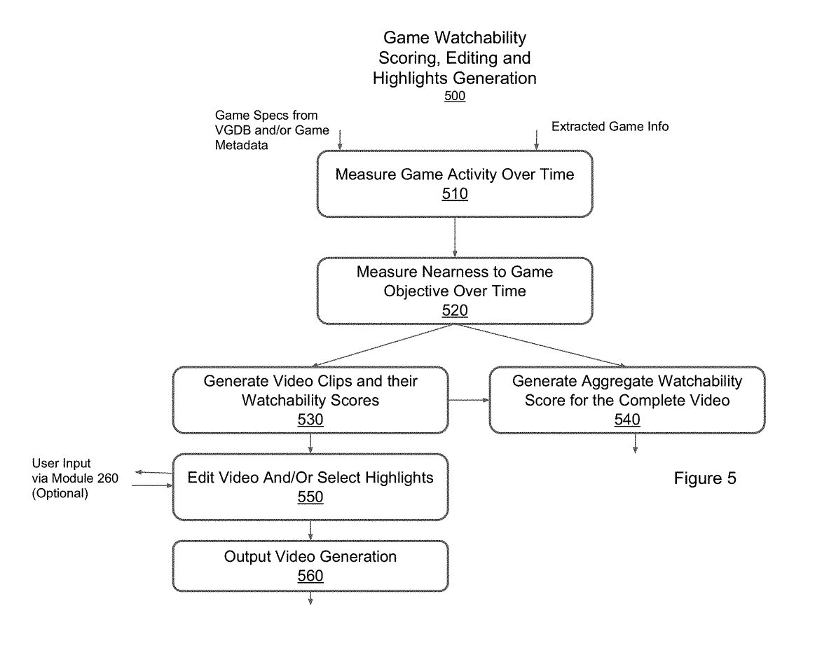

After extracting the status of the video game and/or game activity, game Watchability scoring and highlight generation module 218 differentiates between ‘interesting’ games or portions thereof and ‘boring’ ones or portions thereof through generation of watchability scores. According to one embodiment, watchability scoring and highlight generation module 218 identifies one or more significant portions of the video containing game activity deemed to be of importance and one or more less significant portions of the video deemed to be relatively less important. The relative importance of a particular portion of a video game video may be determined based on various factors including, but not limited to, input received from a viewer and changes in game status and/or game activity. In one embodiment, watchability scoring and highlight generation module 218 analyzes changes in the game score over time and the nearness of a player to completing one or more game objectives to assign a watchability score to the video as a whole and/or to individual portions thereof. A higher watchability score may represent a higher likelihood that viewers will find the video or portions thereof interesting. Watchability scoring and highlight generation module 218 may also generate highlight videos based on watchability scores and/or by performing a separate analysis in relation to player achievements, player scores and/or nearness to completion of game and game level objectives. Module 218 also interacts with the video editing user interface module 260, allowing the user of the system to view and evaluate the game information extracted by system server 210 and provide input in terms of selection of clips, transitions, overlays, and audio in connection with producing a final video output that may be uploaded to YouTube or the like. Non-limiting examples of various processing that may be performed by watchability scoring and highlight generation module 218 are described in further detail below with reference to FIG. 5.

FIG. 3 illustrates processing performed by an exemplary game video feature extraction module (e.g., game video feature extraction module 214) in accordance with an embodiment of the present invention. In the context of the present example, game video feature extraction 300 includes one or more of visual and audio visual feature extraction 310, audio feature extraction 320, Optical Character Recognition (OCR) 330 and speech recognition 340 from a video game video.

Visual and audio visual feature extraction 310 involves the extraction of various visual and audio-visual features from a video at issue. Those skilled in the art will appreciate a variety of visual and audio visual features may be extracted from video data, including, but not limited to, those identified by a Harris-Laplace detector and/or Histogram of Oriented Gradients (HOG) as described in Amir Tamrakar, Saad Ali, Hui Cheng, Harpreet S. Sawhney, “Evaluation of low-level features and their combinations for complex event detection in open source videos,” Computer Vision and Pattern Recognition (CVPR) 2012 at pp. 3681-3688 (hereafter, Tamrakar et al.), which is hereby incorporated by reference in its entirety for all purposes.

Audio feature extraction 320 involves the extraction of various audio features from a video at issue. Those skilled in the art will appreciate a variety of audio features may be extracted from video data, including, but not limited to Mel-Frequency Cepstral Coefficients (MFCC) as described in Tamrakar et al.

OCR 330 involves the extraction of data from one or more of text-based characters (e.g., American Standard Code for Information Interchange (ASCII) characters, alphanumeric characters, non-alphanumeric characters and characters representing the alphabet of various languages in various fonts and/or sizes) and/or text symbols depicted within the video. In embodiments of the present invention OCR 330 may be applied to portions of a video game screen known to contain such textual information (e.g., player names, scores, health information, resource counts, units counts and the like). Those skilled in the art will appreciate a variety video OCR techniques may be applied in connection with video mining. Those desiring more information in this regard may refer to Rainer Lienhart, “Video OCR, A Survey and Practitioner's Guide,” Chapter in Video Mining, The Springer International Series in Video Computing, Vol. 6, 2003, pp. 155-483, which is hereby incorporated by reference in its entirety for all purposes.

Speech recognition 340 involves the extraction of speech from audio data contained within the video. Those skilled in the art will appreciate a variety techniques may be used to detect speech and audio events within video data, including, but not limited to those described in Beigi, Homayoon, “Fundamentals of Speech Recognition.” By Lawrence Rabiner and Bling-Hwang Juang, Prentice Hall 9780130151575 1993 and/or Ziyou Xiong; Radhakrishna.n, R.; Divakaran, A.; Huang, T. S., “Audio events detection based highlights extraction from baseball, golf and soccer games in a unified framework,” IEEE International Conference on Acoustics, Speech, and Signal Processing 2003 (ICASSP '03), vol. 5, no. 6-10, pp. 632-5, April 2003, both of which are hereby incorporated by reference in their entirety for all purposes.

In one embodiment, concurrently with performing extraction of desired features, associated video time and spatial location information are also identified and associated with such features.

FIG. 4 illustrates processing performed by an exemplary game video labeling and information extraction module (e.g., game video labeling and information extraction module 216) in accordance with an embodiment of the present invention. In the context of the present example, a process of game video labeling and information indexing 400 starts at block 410 in which an attempt is made to identify/recognize the video game being shown in the video at issue. In one embodiment, extracted video features (e.g., visual, audio and/or text features extracted by feature extraction module 214) and information regarding possible video games (e.g., game templates/specifications from VGDB 220) are received and compared. According to one embodiment, the video game shown in the video is identified by classifying the frames in a video using classifier models stored in VGDB 220. The classification may be carried out using Support Vector Machine (SVM) classifiers as described in, for example, M. A. Hearst, S. T. Dumais, E. Osman, J. Platt, B. Scholkopf, “Support vector machines,” Intelligent Systems and their Applications, IEEE, vol. 13, no. 4, pp. 18-28, 1998 (hereafter, Hearst, et al.”). Alternatively, Deep Neural Networks as described in, for example, A. Krizhevsky, I. Sutskever, and G. E. Hinton, “ImageNet Classification with Deep Convolutional Neural Networks,” NIPS 2012: Neural Information Processing Systems, Lake Tahoe, Nev. (hereafter, Krizhevsky, et al.), or other classification techniques, such as those described in, for example, Xin Zhang, Yee-Hong Yang, Zhiguang Han, Hui Wang, and/or Chao Gao, “Object class detection: A survey,” ACM Comput. Surv. 46, 1, Article 10 (July 2013) can be used for this purpose. All of the foregoing documents are hereby incorporated by reference in their entirety for all purposes.

Once the game being shown in the video is recognized, at block 420, the temporal extent of the video game depicted in the video is determined by detecting the temporal boundaries of the game in the video. In one embodiment, the temporal boundaries may be computed by training in-game and out of game visual classifiers on the video features. Those skilled in the art will appreciate a variety of artificial intelligence or machine learning methods may be used for this purpose, including, but not limited to neural networks, deep networks, random forest classifiers and the like. In one embodiment, one of more of the techniques described in Hearst, et al. and Krizhevsky, et al. may be used.

At block 430, information is collected about the video game through analysis of one or more game HUDs based upon the information known to be available in such HUDs as indicated by the VGDB 220, for example.

At block 440, information is collected about the video game through analysis of textual information (e.g., player scores, health information, number of lives and the like), which has been previously extracted via OCR, is performed.

At block 450, information is collected about the video game through recognition of game levels, maps, objects and locations. In one embodiment, Support Vector Machines (SVMs), as described in Hearst, et al., are used for recognition and detection of such game information.

At block 460, information is collected about the video game through detection of game achievements. In one embodiment, SVMs, as described in Hearst, et al., are used for recognition and detection of such game information.

At block 470, the information collected/generated by the analysis, detection, recognition and detection of blocks 430, 440, 450 and 460 (collectively, the “extracted game information”) is gathered together (by rule engine 217, for example) to generate game labels, score progression and a game description index. According to one embodiment, a rule engine (e.g., rule engine 217) may obtain knowledge regarding game objectives, character and level depictions, and/or achievements from a video game database (e.g., VGDB 220) and uses this knowledge and game logic to generate video labels and descriptions. According to one embodiment, the rule engine may use case-based reasoning to generate labels for the game video. An explanation of case-based reasoning is provided in Leondes, Cornelius T. “Expert systems: the technology of knowledge management and decision making for the 21st century,” pp. 1-22, 2002, ISBN 978-0-12-443880-4, which is hereby incorporated by reference in its entirety for all purposes. In another embodiment, the rule engine may use First Order Predicate Logic for labeling and description generation. An explanation regarding First Order Predicate Logic is provided in Hazewinkel, Michiel, “Predicate calculus,” Encyclopedia of Mathematics, Springer, ed. 2001, ISBN 978-1-55608-010-4, which is hereby incorporated by reference in its entirety for all purposes.

FIG. 5 illustrates processing performed by an exemplary watchability scoring and highlight generation module (e.g., watchability scoring and highlight generation module 218) in accordance with an embodiment of the present invention. Depending upon the particular implementation and the availability of game metadata information, game watchability scoring and highlight generation 500 may use one or both of the extracted game information and game metadata information corresponding to the video game at issue that is received from outside sources (e.g., via a network or a computer-readable medium) in connection with generating watchability scores and game highlights.

At block 510, the extracted game information and/or the game metadata is analyzed to determine game activity over time. According to one embodiment, game activity is determined based one or more types of information, including, but not limited to the player's game score, opponents' game score, health, change in levels, unit count, image motion and the like.

At block 520, temporal locations within the video in which the player is close to achieving one or more objectives of the video game at issue are detected. In one embodiment, game objectives are obtained from a video game database (e.g., VGDB 220).

At block 530, the game video is segmented into clips and game watchability scores are generated for each clip. In one embodiment, clips are extracted and watchability scores are generated using analysis of game information previously extracted by submodules 510, 520, 216 and/or from game metadata. One embodiment performs time series analysis (see, e.g., Peter J. Brockwell, Richard A. Davis, “Introduction to Time Series and Forecasting,” Edition 2, Series ISSN 1431-875X, Springer-Verlag New York, 2002, which is incorporated by reference herein in its entirety for all purposes) for computing meaningful statistics (e.g. mean, variance and the like) and properties (e.g., local maxima, rate of change etc.) for this data to determine clip boundaries and watchability scores. Clip boundaries may also be determined based on the beginning of, among other things, a new game, level and/or game objective. For purposes of illustrating a non-limiting example of watchability score generation, in game of StarCraft, ‘unit count’ is a type of score/metric that keeps track of players' resources. During a major battle, the unit count often drops rapidly as forces engage an enemy in a battle. As a result, the watchability score, in such a case, is proportional to the rate of change in the time series of ‘unit count’ data, i.e., the higher the rate of change of unit count, the higher the watchability score. Certain scores/metrics may also be used to segment the video into clips by looking at the derivative of such scores/metrics (e.g., unit count), where large changes in the derivate may be used to identify potential clip boundaries. In one embodiment, player achievements and the time locations where the player is close to achieving game objectives as determined in blocks 510 and 520 are used to generate game watchability scores for one or more segments (portions) of the video. For example, in one embodiment, each game achievement may receive a fixed score that is divided by the time remaining for objective completion. Thus, in this scenario, a game achievement near the completion of the game objective will result in a higher watchability score for the particular portion of the video game video.

In one embodiment, a combination of the number of times the player comes close to achieving a game objective (or a level objective), the score of the player with respect to typical player scores, and the player achievements awarded during the game may be used to generate the watchability score. In one embodiment, for games involving multiple opposing players or teams, the number of times the lead changes (in terms of score and/or nearness to one or more game objectives) may be taken into consideration in connection with determining the game watchability score. In some embodiments, the watchability score may be computed based on partial game information, e.g., in the middle of a live game.

At block 540, a watchability score for the entire video as a whole is generated. Those skilled in the art will appreciate there are many possible ways to arrive at a watchability score for the entire video. For example, in one embodiment, the individual segment watchability scores may be aggregated to generate a watchability score for the entire video. In alternative embodiments, an average or mean of the individual video segment watchability scores may be used to represent the watchability score for the entire video as a whole. In other embodiments, the maximum or minimum of the individual segment watchability scores may be used to represent the watchability score for the entire video as a whole. In other embodiments, the number of lead changes between opponents and the closeness of the final score can be used to generate the entire video watchability score. The player ranks (extracted from Game player information 740 from Game Video Info Database 700) can also be used to increase or decrease watchability scores. For example, a video game played by a high ranked player can be assigned a higher watchability score compared to a lower ranked player.

At block 550, highlights are selected (either automatically or based on user input) from the video. Highlights are typically a collection of video segments where important events in the game took place. Such important events may include portions of the video depicting player achievements, level changes, battle victories and the like. In one embodiment, video segments having a watchability score meeting or exceeding a predetermined or configurable threshold are automatically selected for inclusion within a highlight video. In one embodiment, input provided by the user (using Module 260, for example) may be used to partially or fully guide the clip selection for generating the video summary or highlights. As discussed above, the user input may relate to video locations (in terms of time) to be included in the highlights, or conditions relating to game information (e.g., scores, achievement, game level, etc.), which if met should be included in the highlights.

At block 560, a new video containing highlights or any user specified portions of the input (e.g., raw) game video is generated. According to one embodiment, the output video includes only the highlights selected in block 550. The highlight video may be generic (using automatic criteria) and based solely on the watchability scores for individual video segments. Alternatively, the output video may be personalized/customized for a particular user based on (optional) input received from the particular viewer or creator regarding one or more temporal locations within the video to be included in the customized highlight video and/or input regarding one or more conditions relating to the status of the video game. Depending upon the particular implementation, the generated customized output video may include both significant portions of the video containing game activity deemed to be of general importance based on the watchability scores and one or more portions of the video that satisfy the creator or viewer-provided criteria. Alternatively, the generated output video may contain only those portions of the video that satisfy the user-provided criteria. In some embodiments, video segments selected for inclusion in the output video may be combined with:
Suitable splash screens that are either user-specified or automatically selected based on an understanding of the video game content, including one or more of video game activity level, characters/players involved and/or the identified video game;
Transitions that are either user-specified or automatically selected based on video game activity level, characters/players involved and/or the identified video game; and/or
Background music, either user-specified or automatically selected based on video game activity level, characters/players involved and/or the identified video game;

FIG. 6 illustrates a simplified database schema 600 for an exemplary video game database (e.g., VGDB 220) in accordance with an embodiment of the present invention. In one embodiment, database schema facilitates content-specific video parsing, editing, creation and/or labeling as it allows system server 210 to understand the content of the video at issue. In the context of the present example, database schema 600 is represented as a set of exemplary database tables, including a game info table 610, a game HUD table 620, a game objective table 630, a game levels/maps table 640 that includes classification models and a game achievements table 650. In addition, information about any players and teams participating in the game (if available) may also be stored in a player table 670 and teams table 680. Player game history may be stored in a player game history table 660. Fields presented in italic text (i.e., game_id, player_id, team_id, game_HUD_id, game_objective_id, game_level_id and game_achievement_id) are those that serve as primary keys. Id values typically represent values that uniquely identify the thing at issue (e.g., the game, the player, the game HUD specs, the teams, etc.) within the system.

Depending upon the particular implementation, the VGDB may be populated using one or more or a combination of the following approaches:
Manually, e.g., a person collects the game information, game HUD, game objectives, game levels, etc., and populates the VGDB.
Automatically, e.g., a computer program populates the VGDB by (i) scraping information from game information websites (e.g., gamepedia or the like that contain information about the game levels, characters, achievements, etc.); and (ii) analyzing game videos obtained from gaming video websites (e.g., gaming.youtube.com or the like) to obtain game images and HUD locations. The process of scrapping a game information website may be guided by a generic game ontology, which provides relationships among different components of a game. For example, the ontology may provide information that a game goal or objective can be quantified in terms of metrics, such as score, time, success levels, or collectables. Knowing this, the scraping process can crawl the website of a particular game and locate sections describing these metrics either using exactly the same terms (i.e., score, time, collectables) or their synonyms (e.g., count, jewels, etc.). Any text or visual information that is available in the detected section may then be added to the VGDB. The process can then be repeated for populating the other tables (e.g., game achievements, game levels/maps, teams, etc.) within the VGDB. Another way to obtain visual representation of various stages of a game is by querying visual search engines (e.g., Google) using appropriate search terms. For example, the visual representation of the StarCraft in-game screen may be obtained by searching for ‘StarCraft Game Play Screen’.

FIG. 7 illustrates a simplified database schema 700 for a game video information database (e.g., game video info database 230) in accordance with an embodiment of the present invention. In the context of the present example, this database contains the extracted game information. Database schema 700 is represented as a set of exemplary database tables, including a video table 710, a game session boundaries table 720, a game progression table 730, a game player table 740, and a game watchability score table 750. As above, fields presented in italics (i.e., video_id, game_id, session_start_time, time and player_id) are those that serve as primary keys. Note that video table 710 and game player table 740 may also be linked to game info table 610 and player table 670 of FIG. 6.

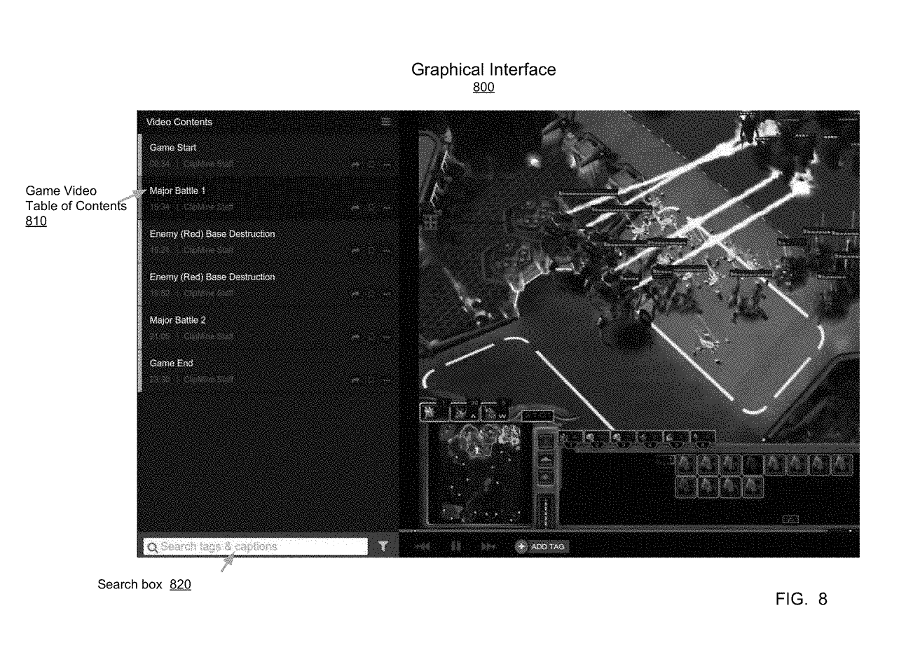

FIG. 8 illustrates an exemplary graphical interface 800 incorporating information extracted and/or generated by a video-game video labeling, information extraction and highlight generation system in accordance with an embodiment of the present invention. In the context of the present example, graphical interface 800 uses the information generated by a video-game video labeling, information extraction and highlight generation system (e.g., system 200) for enhanced browsing and search of a collection of video game videos.

In one embodiment, the generated game progression information may be used to generate a Table of Contents (ToC) 810, which indicates where the actual game session starts in the video, when levels changed or major battles happened in the video game and when the game ended. The viewer can directly click on a TOC entry, e.g., “Game Start,” and jump to the corresponding location in the video.

In the present example, graphical interface 800 also contains a search box 820. Search box 820 can be used by the viewer to search the particular video being viewed. For example, the viewer may enter terms related to the game, e.g., player score, game level, player achievement, player victory etc., to find where in the game these situations occurred. Search box 820 can also be used to search all available videos in a database (e.g., video-game video storage 250), thereby allowing the viewer to search and retrieve, among other things, all videos involving a certain player, all videos having a player of a certain rank, videos involving a particular pair of opponents, the game session with the highest score for a particular game, the game session with the highest number of achievements for a particular game, the game with the highest watchability scores, etc.

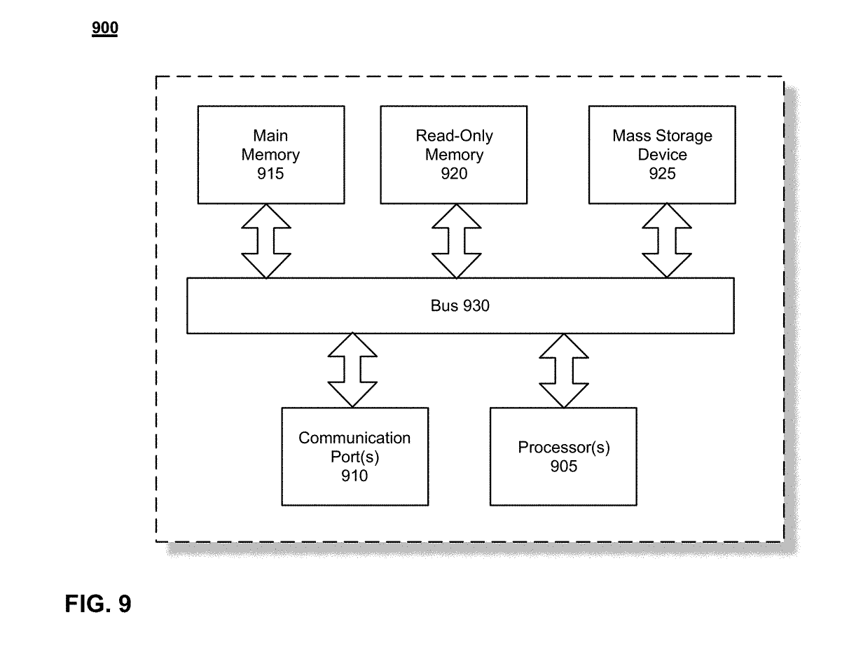

FIG. 9 is an exemplary computer system 900 in which or with which embodiments of the present invention may be utilized. Embodiments of the present disclosure include various steps, which have been described above. A variety of these steps may be performed by hardware components or may be tangibly embodied on a non-transitory computer-readable storage medium in the form of machine-executable instructions, which may be used to cause a general-purpose or special-purpose processor programmed with instructions to perform these steps. Alternatively, the steps may be performed by a combination of hardware, software, and/or firmware.

Computer system 900 may represent or form a part of a server computer system (e.g., system server 210) or may be part of a distributed computer system (not shown) in which various aspects and functions described herein are practiced. The distributed computer system may include one more additional computer systems (not shown) that exchange information with each other and/or computer system 900. The computer systems of the distributed computer system may be interconnected by, and may exchange data through, a communication network (not shown), which may include any communication network through which computer systems may exchange data. To exchange data using the communication network, the computer systems and the network may use various methods, protocols and standards, including, among others, Fibre Channel, Token Ring, Ethernet, Wireless Ethernet, Bluetooth, Internet Protocol (IP), IPv6, Transmission Control Protocol (TCP)/IP, User Datagram Protocol (UDP), Delay-Tolerant Networking (DTN), Hypertext Transfer Protocol (HTTP), File Transfer Protocol (FTP), Simple Network Mail Protocol (SNMP), SMS, MIMS, Signalling System No. 7 (SS7), JavaScript Object Notation (JSON), Simple Object Access Protocol (SOAP), Common Object Request Broker Architecture (CORBA), REST and Web Services. To ensure data transfer is secure, the computer systems may transmit data via the network using a variety of security measures including, for example, Transport Layer Security (TLS), Secure Sockets Layer (SSL) or a Virtual Private Network (VPN).

Various aspects and functions described herein may be implemented as specialized hardware and/or software components executing in one or more computer systems, such as computer system 900. There are many examples of computer systems that are currently in use. These examples include, among others, network appliances, personal computers, workstations, mainframes, networked clients, servers, media servers, application servers, database servers and web servers. Other examples of computer systems may include mobile computing devices (e.g., smartphones, tablet computers and personal digital assistants), and network equipment (e.g., load balancers, routers and switches). Further, various aspects and functionality described herein may be located on a single computer system or may be distributed among multiple computer systems connected to one or more communications networks. For example, various aspects and functions may be distributed among one or more server computer systems configured to provide a service to one or more client computers, or to perform an overall task as part of a distributed system. Additionally, aspects may be performed on a client-server or multi-tier system that includes components distributed among one or more server systems that perform various functions. Consequently, the various aspects and functions described herein are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and the various aspects and functions described herein are not limited to any particular distributed architecture, network, or communication protocol.

Computer system 900 may include a bus 930, a processor 905, communication port 910, a main memory 915, a removable storage media (not shown), a read only memory (ROM) 920 and a mass storage device 925. Those skilled in the art will appreciate that computer system 900 may include more than one processor and more than on communication port.

To implement at least some of the aspects, functions and processes disclosed herein, processor 905 performs a series of instructions that result in manipulated data. Processor 905 may be any type of processor, multiprocessor or controller. Some exemplary processors include commercially available processors such as an Intel Xeon, Itanium, Core, Celeron, or Pentium processor, an AMD Opteron processor, a Sun UltraSPARC or IBM Power5+ processor and an IBM mainframe chip. Processor 905 is connected to other system components, including one or more memory devices representing main memory 915, ROM 920 and mass storage device 925 via bus 930.

Main memory 915 stores programs and data during operation of computer system 900. Thus, main memory 915 may be a relatively high performance, volatile, random access memory (e.g., dynamic random access memory (DRAM) or static memory (SRAM)). However, main memory 915 may include any device for storing data, such as a disk drive or other non-volatile storage device. Various examples may organize main memory 915 into particularized and, in some cases, unique structures to perform the functions disclosed herein. These data structures may be sized and organized to store values for particular data and types of data.

Components of computer system 900 are coupled by an interconnection element, such as bus 930. Bus 930 may include one or more physical busses, for example, busses between components that are integrated within the same machine, but may include any communication coupling between system elements including specialized or standard computing bus technologies including, but not limited to, Integrated Drive Electronics (IDE), Small Computer System Interface (SCSI), Peripheral Component Interconnect (PCI) and InfiniBand. Bus 930 enables communications of data and instructions, for example, to be exchanged between system components of computer system 900.

Computer system 900 typically also includes one or more interface devices (not shown), e.g., input devices, output devices and combination input/output devices. Interface devices may receive input or provide output. More particularly, output devices may render information for external presentation. Input devices may accept information from external sources. Non-limiting examples of interface devices include keyboards, mouse devices, trackballs, microphones, touch screens, printing devices, display screens, speakers, network interface cards, etc. Interface devices allow computer system 900 to exchange information and to communicate with external entities, e.g., users and other systems.

Mass storage device 925 includes a computer readable and writeable nonvolatile, or non-transitory, data storage medium in which instructions are stored that define a program or other object that is executed by processor 905. Mass storage device 925 also may include information that is recorded, on or in, the medium, and that is processed by processor 905 during execution of the program. More specifically, the information may be stored in one or more data structures specifically configured to conserve storage space or increase data exchange performance. The instructions may be persistently stored as encoded signals, and the instructions may cause processor 905 to perform any of the functions described herein. The medium may, for example, be optical disk, magnetic disk or flash memory, among others. In operation, processor 905 or some other controller causes data to be read from the nonvolatile recording medium into another memory, such as main memory 915, that allows for faster access to the information by processor 905 than does the storage medium included in mass storage device 925. A variety of components may manage data movement between main memory 915, mass storage device 925 and other memory elements and examples are not limited to particular data management components. Further, examples are not limited to a particular memory system or data storage system.

Communication port 910 may include, but is not limited to, an RS-232 port for use with a modem based dialup connection, a 10/100 Ethernet port, a Gigabit or 10 Gigabit port using copper or fiber, a serial port, a parallel port, or other existing or future ports. Communication port 610 may be chosen depending on a network, such a Local Area Network (LAN), Wide Area Network (WAN), or any network to which computer system 900 connects.

Removable storage media can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Although computer system 905 is shown by way of example as one type of computer system upon which various aspects and functions may be practiced, aspects and functions are not limited to being implemented on computer system 900. Various aspects and functions may be practiced on one or more computers having a different architecture or components than that shown in FIG. 9. For instance, computer system 900 may include specially programmed, special-purpose hardware, such as an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

Computer system 900 may include an operating system (not shown) that manages at least a portion of the hardware elements included in computer system 900. In some examples, a processor or controller, such as the processor 905, executes the operating system. Non-limiting examples of operating systems include a Windows-based operating system, such as, Windows NT, Windows 2000 (Windows ME), Windows XP, Windows Vista or Windows 7 operating systems, available from Microsoft Corporation, a MAC OS System X operating system available from Apple Inc., one of many Linux-based operating system distributions, for example, the Enterprise Linux operating system available from Red Hat Inc., a Solaris operating system available from Sun Microsystems, or a UNIX operating systems available from various sources. Many other operating systems may be used.

Processor 905 and operating system together define a computer platform for which application programs in high-level programming languages may be written. These applications may be executable, intermediate, bytecode or interpreted code, which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in Hypertext Markup Language (HTML), eXtensible Markup Language (XML) or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects, that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Components described above are meant only to exemplify various possibilities. In no way should the aforementioned exemplary computer system limit the scope of the present disclosure.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A computer-implemented method comprising:
receiving, by a video input module running on one or more computer systems, a video containing content pertaining to a video game;
receiving, by a highlight generation module running on the one or more computer systems, information relating to a status of the video game over time;
identifying, by the highlight generation module, based on the information relating to the status of the video game over time, one or more significant portions of the video containing game activity deemed to be of importance and one or more less significant portions of the video deemed to be relatively less important than the one or more significant portions; and
generating, by the highlight generation module, a highlight video corresponding to the video that includes the one or more identified significant portions and excludes the one or more less significant portions.

2. The method of claim 1, further comprising:
receiving input from a user indicative of one or more aspects or timeframes of the video that would be of interest to the user for inclusion within the highlight video; and
wherein said generating is based at least in part on the user input.

3. The method of claim 2 wherein the input comprises one or more conditions relating to the status of the video game and wherein the method further comprises:
identifying, by the highlight generation module, portions of the video in which the status of the video game meets the one or more conditions; and
including within the customized highlight video, by the highlight generation module, the one or more identified user-designated portions.

4. The method of claim 1, wherein said receiving, by a highlight generation module running on the one or more computer systems, information relating to a status of the video game over time comprises retrieving game metadata through an Application Programming Interface (API) of the video game.

5. The method of claim 1, further comprising extracting, by a feature extraction module running on the one or more computer systems, the information relating to the status of the video game over time by analyzing audio or visual features within the content.

6. The method of claim 5, further comprising:
extracting, by the feature extraction module, information indicative of the video game;
identifying, by the feature extraction module, the video game by one or more of (i) comparing aspects of the information indicative of the video game to one or more stored game design templates and (ii) classifying frames within the video using stored classification models.

7. The method of claim 1, further comprising automatically identifying and inserting within the highlight video one or more of a splash screen, inter-clip transitions and background music based at least in part on one or more of the identified video game and activity level of the video game.

8. The method of claim 1, wherein the status of the video game comprises one or more of:
information regarding a score of one or more players of the video game;
information regarding a unit count of the one or more players;
information regarding a battle victory achieved by the one or more players;
information regarding nearness to or completion of a player achievement within the video game by the one or more players;
information regarding a health of the one or more players;
information regarding a level of the one or more players; and
information regarding nearness to or completion of an objective of the one or more objectives.

9. The method of claim 1, further comprising generating, by a rule engine running on the one or more server systems, one or more of game labels, score progression and a description index for the highlight video.

10. A computer-implemented method comprising:
receiving, by a video input module running on one or more computer systems, a video containing content pertaining to a video game;
receiving, by an indexing module running on the one or more computer systems, information relating to a status of the video game over time;
automatically identifying, by the indexing module, a plurality of clips within the video for proposed inclusion within an edited version of the video based on the status of the video game over time; and
generating the edited version of the video by (i) joining all of the plurality of automatically identified clips or (ii) joining a plurality of user-selected clips, wherein a user selects at least one of the plurality of automatically identified clips.

11. The method of claim 10, wherein said receiving, by an indexing module running on the one or more computer systems, information relating to a status of the video game over time comprises retrieving game metadata through an Application Programming Interface (API) of the video game.

12. The method of claim 10, further comprising extracting, by a feature extraction module running on the one or more computer systems, the information relating to the status of the video game over time by analyzing one or more of audio or visual features within the content.

13. The method of claim 10, further comprising determining, by a feature extraction module running on the one or more computer systems, an identity of the video game by one or more of (i) matching video features extracted from the content with video features of a plurality of stored video game models that are accessible to the feature extraction module and (ii) classifying frames within the video using stored classification models.

14. The method of claim 10, wherein the status of the video game comprises one or more of:
information regarding a score of one or more players of the video game;
information regarding a unit count of the one or more players;
information regarding a battle victory achieved by the one or more players;
information regarding nearness to or completion of a player achievement within the video game by the one or more players;
information regarding a health of the one or more players;
information regarding a level of the one or more players; and
information regarding nearness to or completion of an objective of the one or more objectives.

15. The method of claim 10, further comprising automatically identifying and inserting within the shortened version of the video one or more of a splash screen, inter-clip transitions and background music based at least in part on one or more of the determined identity of the video game and activity level of the video game.

16. A computer-implemented method comprising:
receiving, by a video input module running on one or more computer systems, a video containing content pertaining to a video game;
extracting, by a feature extraction module running on the one or more computer systems, information relating to a status of the video game over time by performing video processing of the video; and
creating, by a labeling and indexing module running on the one or more computer systems, a table of contents (ToC) for the video to be used during a subsequent playback of the video by programmatically generating game labels, score progressions and descriptions corresponding to a plurality of timeframes within the video based on the extracted information relating to the status of the video game over time.

17. The method of claim 16, wherein said performing video processing of the video comprises one or more of (i) analyzing a heads up display (HUD) presented within a user interface of the video game; and (ii) detecting a score of one or more players of the video game.

18. The method of claim 16, wherein said performing video processing of the video comprises detecting completion of an achievement with reference to the video features and information regarding achievements for the video game stored in the video game database.

19. The method of claim 16, wherein the status of the video game comprises one or more of:
information regarding a score of one or more players of the video game;
information regarding a unit count of the one or more players;
information regarding a battle victory achieved by the one or more players;
information regarding nearness to or completion of a player achievement within the video game by the one or more players;
information regarding a health of the one or more players;
information regarding a level of the one or more players; and
information regarding nearness to or completion of an objective of the one or more objectives.

20. The method of claim 16, further comprising determining, by the feature extraction module, an identity of the video game by one or more of (i) matching video features extracted from the content with video features of a plurality of video game models stored in a video game database that is accessible to the feature extraction module; and (ii) classifying frames within the video using classifier models stored in the video game database.

21. The method of claim 20, wherein said performing video processing of the video comprises recognizing a current level, map or character within the video game by one or more of (i) comparing the video features with corresponding video features associated with the video game and stored in the video game database and (ii) classifying image regions in frames within the video using classifier models stored in the video game database.

22. A computer-implemented method comprising:
receiving, by a video input module running on one or more computer systems, a video comprising a plurality of segments each containing content pertaining to a video game;
receiving, by a scoring module running on the one or more computer systems, information relating to a status of the video game over time;
generating, by the scoring module, segment watchabilty scores for each of the plurality of segments based on one or more of statistics and properties resulting from a time series analysis of the information relating to the status of the video game over time; and
assigning, by the scoring module, a watchability score to the video as a whole based on the segment watchability scores.

23. The method of claim 22, further comprising extracting, by a feature extraction module running on the one or more computer systems, the information relating to the status of the video game over time by analyzing audio or visual features within the content.

24. The method of claim 22, wherein said assigning, by the scoring module, a watchability score to the video as a whole based on the segment watchability scores comprises aggregating the segment watchability scores.

25. The method of claim 22, wherein said assigning, by the scoring module, a watchability score to the video as a whole based on the segment watchability scores comprises setting the watchability score to an average or a mean of the segment watchability scores.

26. The method of claim 22, receiving, by a scoring module running on the one or more computer systems, information relating to a status of the video game over time comprises retrieving game metadata through an Application Programming Interface (API) of the video game.
